(19) United States
(12) Patent Application Publication
(10) Pub. No.: US 2019/0277085 A1
(43) Pub. Date: Sep. 12, 2019

(54) PULL CORD SAFETY DEVICE FOR A WINDOW COVERING

(71) Applicant: Ya-Yin LIN, Chiayi City (TW)

(72) Inventor: Ya-Yin LIN, Chiayi City (TW)

(21) Appl. No.: 15/917,167

(22) Filed: Mar. 9, 2018

(51) Int. Cl. E06B 9/326; E06B 9/325

(52) U.S. Cl. CPC E06B 9/326; E06B 2009/583; E06B 2009/3265; E06B 9/325

(57) ABSTRACT

A pull cord safety device includes a pull cord and a safety unit allowing extension of the pull cord. The safety unit includes a plurality of barrier units. Each barrier unit includes two front barrier ropes and two rear barrier ropes. Each front barrier rope has a front portion extending across and disposed forwardly of the pull cord, and a first intersection portion connected to the front portion. Each rear barrier rope has a rear portion extending across and disposed rearward of the pull cord, and a second intersection portion connected to the rear portion and intersecting and disposed forwardly of the first intersection portion.

### FIELD

The disclosure relates to a pull cord safety device, and more particularly to a pull cord safety device for a window covering.

### BACKGROUND

To prevent a pull cord used in a window covering from being played by children and being wrapped around a child's neck, U.S. Pat. No. 9,074,409 proposes a pull cord safety device, which is suitable for being assembled to a window covering and which includes a safety unit for a pull cord to extend therethrough. The safety unit includes a plurality of horizontally spaced-apart front and rear connection segments to block the pull cord from being pulled out and played by children. However, every two adjacent front connection segments and every two adjacent rear connection segments form a rectangular hole that has relatively high two lateral sides, which can allow a child's finger to pull out the pull cord from the rectangular hole. Therefore, the pull cord safety device is unsafe and can lead to a potential hazard in use. Although increasing density of the front and rear connection segments can minimize the height of the rectangular holes thereof, manufacture cost of the pull cord safety device can be increased.

As shown in FIG. 1, to avoid the aforesaid drawback, a pull cord safety device, disclosed in Taiwanese Utility Model Patent No. M544274, is provided with a safety unit 1 and a pull cord 2 extending through the safety unit 1 in a top-bottom direction 20. The safety unit 1 includes two parallel spaced-apart lateral ropes 11 and a plurality of barrier units 120 spaced apart from each other along the top-bottom direction 20. Each barrier unit 120 includes two front barrier ropes 121 extending obliquely in a left-right direction across the pull cord 2 and disposed forwardly of the pull cord 2, and two rear barrier ropes 122 extending obliquely in the left-right direction across the pull cord 2 and disposed rearward of the pull cord 2. The two rear barrier ropes 122 respectively intersect with the front barrier ropes 121.

For each barrier unit 120, because adjacent front and rear barrier ropes 121, 122 respectively and obliquely intersect with each other, lateral heights of holes formed by the front and rear barrier ropes 121, 122 are reduced. However, because the front barrier ropes 121 are disposed entirely at the front of the pull cord 2 and the rear barrier ropes 122 are disposed entirely at the rear of the pull cord 2, the pull cord is movable randomly in the left-right direction and therefore is ineffectively positioned. The child's finger is still able to enter the holes to pull out the pull cord 2 from a wider spacing between the front barrier ropes 121.

On the other hand, if two pull cords 2 are disposed within barrier units 120, because the front barrier ropes 121 are entirely at the front of the two pull cords 2 and the rear barrier ropes 122 are entirely at the rear of the two pull cords 2, the two pull cords 2 will be moved close to and entangled with each other. Therefore, the aforesaid pull cord safety device is suitable only for a single pull cord, and the usage thereof is limited.

### SUMMARY

Therefore, an object of the disclosure is to provide pull cord safety device that can alleviate at least one of the drawbacks of the prior art.

According to the disclosure, a pull cord safety device includes at least one pull cord extending in a top-bottom direction and a safety unit allowing extension of the at least one pull cord therethrough. The safety unit includes a plurality of battier units disposed along the top-bottom direction. Each of the battier units includes two front barrier ropes and two rear barrier ropes.

The front barrier ropes extend obliquely in a left-right direction and across the at least one pull cord. Each of the front barrier ropes has at least one front portion extending across and at the front of the at least one pull cord, and a first intersection portion connected to the at least one front portion.

The rear barrier ropes extend obliquely in the left-right direction and across the at least one pull cord. Each of the rear barrier ropes has at least one rear portion extending across and at the rear of the at least one pull cord, and a second intersection portion connected to the at least one rear portion and intersecting the first intersection portion at the front of the first intersection portion.

### BRIEF DESCRIPTION OF THE DRAWINGS

Other features and advantages of the disclosure will become apparent in the following detailed description of the embodiments with reference to the accompanying drawings, of which:

FIG. 1 is a front view, illustrating a pull cord safety device disclosed in Taiwanese Utility Model Patent No. M544274;

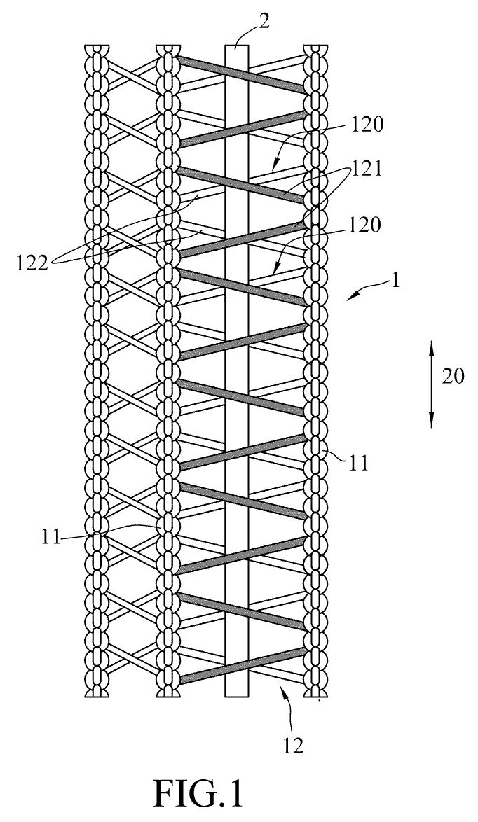

FIG. 2 is a front view, illustrating a pull cord safety device according to a first embodiment of the present disclosure;

FIG. 3 illustrates the pull cord safety device of the first embodiment assembled to a window covering; and

FIG. 4 is a front view, illustrating a pull cord safety device according to a second embodiment of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

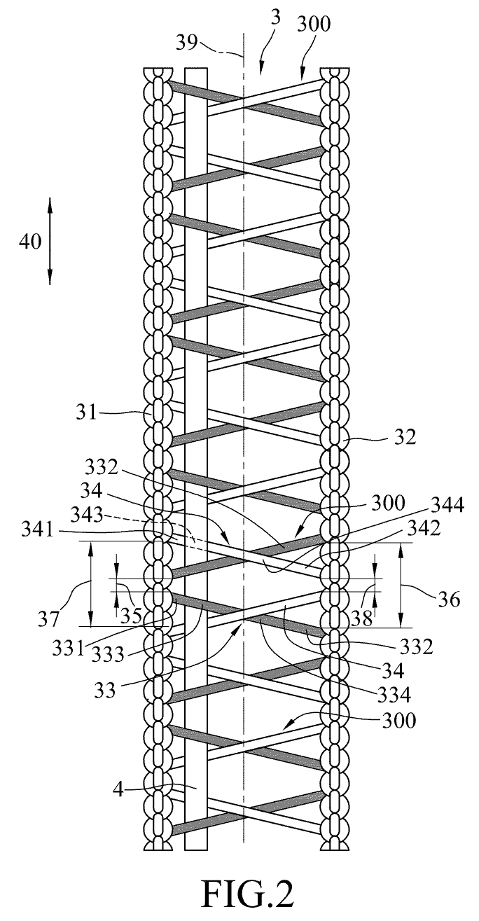

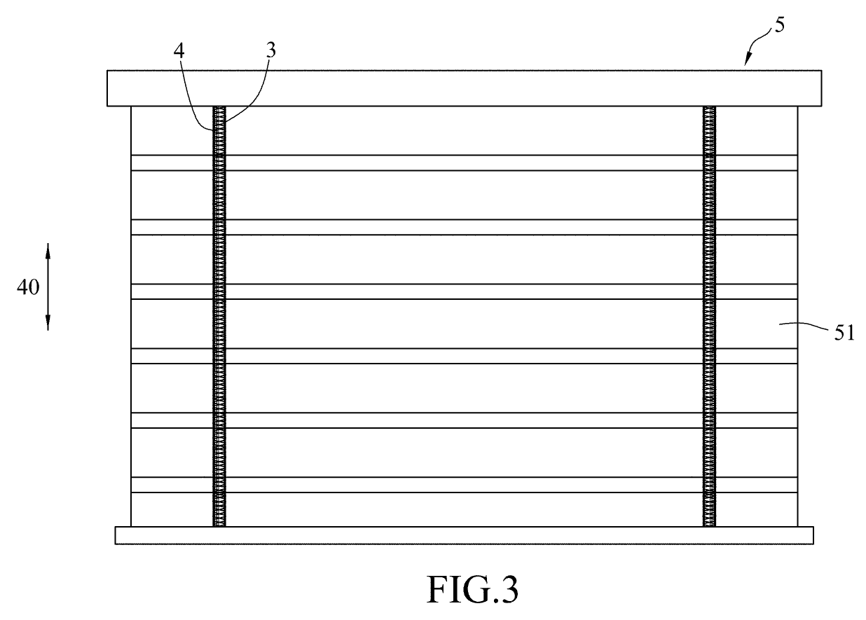

Referring to FIGS. 2 and 3, a pull cord safety device according to a first embodiment of the disclosure includes is suitable for a window covering 5. The window covering 5 has a curtain 51 vertically foldable and unfoldable. The pull cord safety device is made from a woven fabric. The pull cord safety device includes a safety unit 3 that is structured in a net form and that is fastened to the curtain 51 at equal intervals, and a pull cord 4 that extends in a top-bottom direction 40 through the safety unit 3 and that is operable to vertically fold or unfold the curtain 51. The safety unit 3 includes a first lateral rope 31 extending along the top-bottom direction 40, a second lateral rope 32 spaced apart in a left-right direction from the first lateral rope 31, and a plurality of barrier units 300 that is connected between the first and second lateral ropes 31, 32 and that is disposed along the top-bottom direction 40. The first and second lateral ropes 31, 32 are, but not limited to, formed from braided yarns and have a chain-like structure.

Each barrier unit 300 includes two front barrier ropes 33 extending obliquely in a left-right direction and across the pull cord 4, and two rear barrier ropes 34 extending obliquely in the left-right direction and across the cord 4. One of the rear barrier ropes 34 intersects with one of the front barrier ropes 33.

Each front barrier rope 33 has a first end portion 331, a second end portion 332, a front portion 333 and a first intersection portion 334. The first end portion 331 connects the first lateral rope 31. The second end portion 332 connects the second lateral rope 32. The first intersection portion 334 is disposed between the first and second end portions 331, 332. The front portion 333 is proximal to the first end portion 331. Particularly, the front portion 333 is disposed between the first intersection portion 334 and the first end portion 331 and extends across and at the front of the pull cord 4. The first intersection portion 334 is connected to the front portion 333 and the second end portion 332.

Each rear barrier rope 34 has a third end portion 341, a fourth end portion 342, a rear portion 343 and a second intersection portion 344. The third end portion 341 connects the first lateral rope 31. The fourth end portion 342 connects the second lateral rope 32. The second intersection portion 344 is disposed between the third and fourth end portions 341, 342. The rear portion 343 is proximal to the third end portion 341. Particularly, the rear portion 343 is disposed between the second intersection portion 344 and the third end portion 341 and extends across and at the rear of the pull cord 4. The second intersection 344 is connected to the rear portion 343 and the fourth end portion 342, and intersects the first intersection portion 334 at the front of the first intersection portion 334.

For each barrier unit 300, a first width 35 between the first end portions 331 of the front barrier ropes 33 is smaller than a second width 36 between the second end portions 332 of the front barrier ropes 33. Moreover, for each barrier unit 300, a third width 37 between the third end portions 341 of the rear barrier ropes 34 is greater than a fourth width 38 between the fourth end portions 342 of the rear barrier ropes 34. The first width 35 is equal to the fourth width 38. The second width 36 is equal to the third width 37.

During assembly of the pull cord safety device of the disclosure to the window covering 5, each of the first and second lateral ropes 31, 32 has at least one end fixedly connected to the curtain 51. The pull cord 4 is arranged to consecutively extend through the barrier units 300 in the top-bottom direction 40 in such a manner that the front portion 333 of each front barrier rope 33 is disposed at the front of the pull cord 4 and the rear portion 343 of each rear barrier rope 34 is disposed at the rear of the pull cord 4. Because the second intersection portion 344 of each rear barrier rope 34 intersects and is disposed at the front of the first intersection portion 334 of the respective front barrier rope 33, after the pull cord 4 extends through the barrier units 300, the first and second intersection portions 334, 344 are situated substantially on a middle line 39 that extends midway between the first and second lateral ropes 31, 32, and the pull cord 4 is limited between the middle line 39 and the first later rope 31. In such a way, the pull cord 4 is limited from randomly moving along the left-right direction, thus increasing difficulties for children to pull out the pull cord 4 from the barrier units 300. Therefore, the safeness of the pull cord safety device of the disclosure is enhanced.

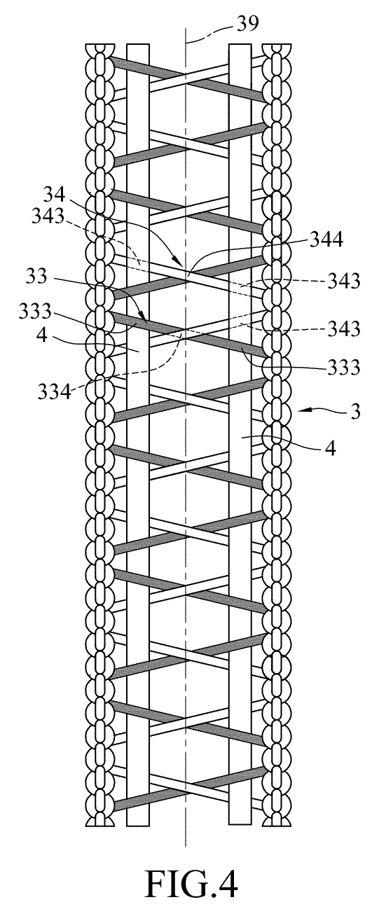

FIG. 4 illustrates a pull cord safety device according to a second embodiment of the disclosure, which is generally similar to that of the first embodiment. However, in the second embodiment, the pull cord safety device of the disclosure includes two pull cords 4 respectively disposed on two opposite sides of the middle line 39. Each front barrier rope 33 includes two front portions 333 each extending across and disposed forwardly of the pull cords 4. Each rear barrier rope 34 includes two rear portions 343 each extending across and disposed rearward of the pull cords 4. The first intersection portion 334 is disposed on the middle line 39 and connected between the two front portions 333. The second intersection portion 344 is disposed on the middle line 39 and connected between the two rear portions 343. One of the front portions 333 is disposed between the first intersection portion 334 and the first end portion 331. The other one of the front portions 333 is between the first intersection portion 334 and the second end portion 332. One of the rear portions 343 is disposed between the second intersection portion 344 and the third end portion 341. The other one of the rear portions 343 is between the second intersection portion 344 and the fourth end portion 342. Therefore, one of the pull cords 4 is limited between the first lateral rope 31 and the middle line 39 by the first intersection portions 334 of the front barrier ropes 33 and the second intersections 344 of the rear barrier ropes 34. The other one of the pull cords 4 is limited between the middle line 39 and the second lateral rope 32 by the first intersection portions 334 of the front barrier ropes 33 and the second intersections 344 of the rear barrier ropes 34. By virtue of the disposition of the first intersection portions 334 of the front barrier ropes 33 and the second intersections 344 of the rear barrier ropes 34, the pull cords 4 are isolated from each other and prevented from touching each other, or being entangled with each other.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A pull cord safety device for a window covering, comprising:
at least one pull cord extending in a top-bottom direction; and
a safety unit allowing extension of said at least one pull cord therethrough, said safety unit including a plurality of barrier units disposed along the top-bottom direction, each of said barrier units including
two front barrier ropes extending obliquely in a left-right direction and across said at least one pull cord, each of said front barrier ropes having at least one front portion disposed across and at the front of said at least one pull cord, and a first intersection portion connected to said at least one front portion, and
two rear barrier ropes extending obliquely in the left-right direction and across said at least one pull cord, each of said rear barrier ropes having at least one rear portion disposed across and at the rear of said at least one pull cord, and a second intersection portion connected to said at least one rear portion and intersecting said first intersection portion at the front of said first intersection portion.

2. The pull cord safety device as claimed in claim 1, wherein said safety unit further includes a first lateral rope extending along the top-bottom direction, and a second lateral rope spaced apart from said first lateral rope, said barrier units being connected between said first and second lateral ropes.

3. The pull cord safety unit as claimed in claim 2, wherein:
each of said front barrier ropes further has a first end portion proximal to said at least one front portion and connecting said first lateral rope, and a second end portion proximal to said first intersecting portion and connecting said second lateral rope; and
each of said rear barrier ropes further has a third end portion proximal to said at least one rear portion and connecting said first lateral rope, and a fourth end portion proximal to said second intersection portion and connecting said second lateral rope.

4. The pull cord safety device as claimed in claim 3, wherein, for each of said barrier units, a first width between said first end portions of said front barrier ropes is smaller than a second width between said second end portions of said front barrier ropes.

5. The pull cord safety device as claimed in claim 3, wherein, for each of said barrier units, a third width between said third end portions of said rear barrier ropes is greater than a fourth width between said fourth end portions of said rear barrier ropes.

6. The pull cord safety device as claimed in claim 5, wherein, for each of said barrier units, a first width between said first end portions of said front barrier ropes is smaller than a second width between said second end portions of said front barrier ropes.

7. The pull cord safety device as claimed in claim 6, wherein said first width is equal to said fourth width, said second width being equal to said third width.

8. The pull cord safety device as claimed in claim 6, wherein a middle line extends midway between said first and second lateral ropes, said at least one pull cord including two pull cords respectively disposed on two opposite sides of the middle line, said at least one front portion of each of said front barrier ropes including two front portions respectively disposed at two opposite sides of said first intersection portion and each extending across and at the front of one of said pull cords, said at least one rear portion of each of said rear barrier ropes including two rear portions respectively disposed at two opposite sides of said second intersection portion and each extending across and at the front of one of said pull cords.

9. The pull cord safety unit as claimed in claim 2, wherein a middle line extends midway between said first and second lateral ropes, said at least one pull cord including two pull cords respectively disposed on two opposite sides of the middle line, said at least one front portion of each of said front barrier ropes including two front portions each extending across and at the front of one of said pull cords, said at least one rear portion of each of said rear barrier ropes including two rear portions each extending across and at the rear one of said pull cords.

10. The pull cord safety unit as claimed in claim 9, wherein said first intersection portion is connected between said two front portions, and said second intersection portion is connected between two said rear portions.

11. A pull cord safety device for a window covering, comprising:
a safety unit including a plurality of barrier units disposed along the top-bottom direction; and
at least one pull cord extending in a top-bottom direction through said barrier units;
each of said barrier units including
two front barrier ropes extending obliquely in a left-right direction and across said at least one pull cord, each of said front barrier ropes having first and second end portions, a first intersection portion disposed between said first and second end portions, and at least one front portion that is disposed between said first intersection portion and at least one of said first and second end portions and that extends across and at the front of said at least one pull cord;
two rear barrier ropes extending obliquely in the left-right direction and across said at least one pull cord, each of said rear barrier ropes having third and fourth end portions, a second intersection portion that is disposed between said third and fourth end portions and that intersects said first intersection portion at the front of said first intersection portion, and at least one rear portion that is disposed between said second intersection portion and at least one of said third and fourth end portions and that extends across and at the rear of said at least one pull cord.

12. The pull cord safety device as claimed in claim 11, wherein said safety unit further includes a first lateral rope extending along the top-bottom direction, and a second lateral rope spaced apart from said first lateral rope, said first end portions of said front barrier ropes and said third end portions of said rear barrier ropes being connected to said first lateral rope, said second end portions of said front barrier ropes and said fourth end portions of said rear barrier ropes being connected to said second lateral rope.
